(19) United States
(12) Patent Application Publication
(10) Pub. No.: US 2007/0141441 A1
(43) Pub. Date: Jun. 21, 2007

(54) Fuel cell having composite bipolar plates

(76) Inventors: Shuo-Jen Lee, Taipei City (TW); Chi-Yuan Lee, Lujhu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/443,043

(22) Filed: May 31, 2006

(30) Foreign Application Priority Data
Dec. 19, 2005 (TW) 094145113

(51) Int. Cl. H01M 8/02

(52) U.S. Cl. 429/38

(57) ABSTRACT

A fuel cell having composite bipolar plates mainly includes a pair of bipolar plates. Each bipolar plate has a first surface and a second surface. Each bipolar plate including a conductive plastic plate, a plastic plate fluid inlet, a plastic plate fluid outlet, and a substantially recessed channel. This metal plate has a first metal surface and a second metal surface. The first metal surface is disposed on the second surface of the bipolar plate. The second metal surface is connected with the second plastic surface. Therefore, it can significantly reduce the manufacturing cost. Its anti-corrosion capability is excellent. And, it can produce fuel cells having complicated bipolar structures.

### BACKGROUND OF INVENTION

1. Field of the Invention

This invention relates to a fuel cell having composite bipolar plates. Particularly, it relates to a fuel cell having composite plastic and metal bipolar plates. It can significantly reduce the manufacturing cost. Its anti-corrosion capability is excellent. And, it can produce fuel cells having complicated bipolar structures.

2. Description of the Prior Art

The conventional bipolar plates are made by carbon. This kind of carbon-carbon bipolar plates has an excellent electricity generating function. If the bipolar plates are made by specific metal, the bipolar plates can be manufactured by rolling, forging, precision forging, powder metallurgy, etc. In addition, if the bipolar plates are made by a plastic material (having poor strength and poor electrical conductivity), its manufacturing method at least has injection molding, heat-pressing, etc. However, they still have the following disadvantages or problems:

[1] The manufacturing cost is high. Regarding the conventional carbon-carbon bipolar plates, it has excellent electricity generating performance, but the cost is too high. Assuming the cost for one single bipolar plate is roughly around several hundred US dollars, the cost of the fuel cell stack containing ten pair of bipolar plates will reach several thousand US dollars. However, the electricity generated by the conventional fuel cell is quite low (not proportional to its high cost). Therefore, it is hard to compete with others in a commercial market. And, it is very difficult to promote the fuel cell and make it popularized.

[2] It is easy to be corroded. If the bipolar plates are made by metal, it is very easy to be corroded by the water generated inside the fuel cell. Thus, it will influence its flowing smoothness in the channel inside the fuel cell. Furthermore, it might cause the electricity generating unstable or reduce its using life.

[3] It cannot manufacture a fuel cell with complicated bipolar plates. When the bipolar structures are very complicated, its manufacturing process is complex and time-consuming, no matter it is made by carbon-carbon bipolar plates or by pure-metal bipolar plates. So, it is not suitable for mass production.

### SUMMARY OF THE INVENTION

The primary object of the present invention is to provide a fuel cell having composite bipolar plates that can significantly reduce the manufacturing cost.

The next object of the present invention is to provide a fuel cell having composite bipolar plates. In which, its anti-corrosion capability is excellent.

Another object of the present invention is to provide a fuel cell having composite bipolar plates. It can produce fuel cells having complicated bipolar structures.

In order to achieve the above-mentioned objects, the present invention is provided. A fuel cell having composite bipolar plates comprising a pair of bipolar plates, each bipolar plate having a first surface and a second surface, each bipolar plate including:

a conductive plastic plate having a first plastic surface and a second plastic surface, said first plastic surface being disposed on said first surface, said conduction plastic portion comprising:
(a) a plastic plate fluid inlet;
(b) a plastic plate fluid outlet; and
(c) a substantially recessed channel formed on said first plastic surface of said conductive plastic plate; and

a metal plate having a first metal surface and a second metal surface, said first metal surface being disposed on said second surface of said bipolar plate, said second metal surface being connected with said second plastic surface.

### BRIEF DESCRIPTION OF THE DRAWING

FIG. 1 is a perspective view of the present invention.

FIG. 2 is a cross-sectional view of a selected portion of this invention.

FIG. 3 is a cross-sectional view of another selected portion of this invention.

FIG. 4 is a perspective view of the present invention before assembling.

FIG. 5 is a view showing the inner structure inside the present invention.

FIG. 6 illustrates a process for manufacturing the present invention.

FIG. 7 illustrates another process for manufacturing the present invention.

FIG. 8 shows the final product of the present invention.

### DETAILED DESCRIPTION OF THE PREFERRED EMBODIMENT

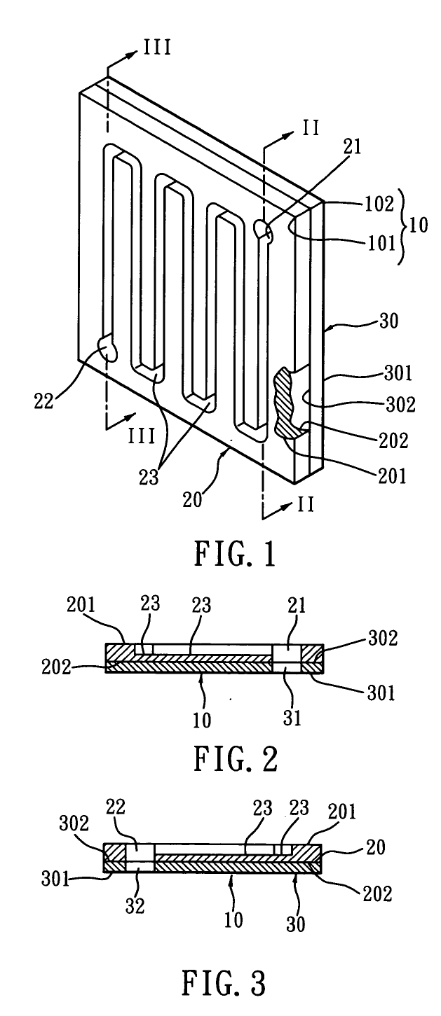

The present invention is a fuel cell having composite bipolar plates. Referring to FIGS. 1 to 3, this invention comprises a pair of bipolar plates 10. Each bipolar plate 10 has a first surface 101 and a second surface 102. Each bipolar plate 10 includes a conductive plastic plate 20 and a metal plate 30.

About this conductive plastic plate 10, it has a first plastic surface 201 and a second plastic surface 202. The first plastic surface 201 is disposed on the first surface 10l. The conductive plastic portion 20 comprising:
(a) a plastic plate fluid inlet 21;
(b) a plastic plate fluid outlet 22; and
(c) a substantially recessed channel 23 formed on the first plastic surface 201 of the conductive plastic plate 20.

With regard to this metal plate 30, it has a first metal surface 301 and a second metal surface 302. This first metal surface 301 is disposed on the second surface 102 of the bipolar plate 10. The second metal surface 302 is connected with the second plastic surface 102.

Thus, the structure of the bipolar plates is solid and it has a highly electrical conductivity. Also, their mechanical strength and anti-corrosion capability are excellent.

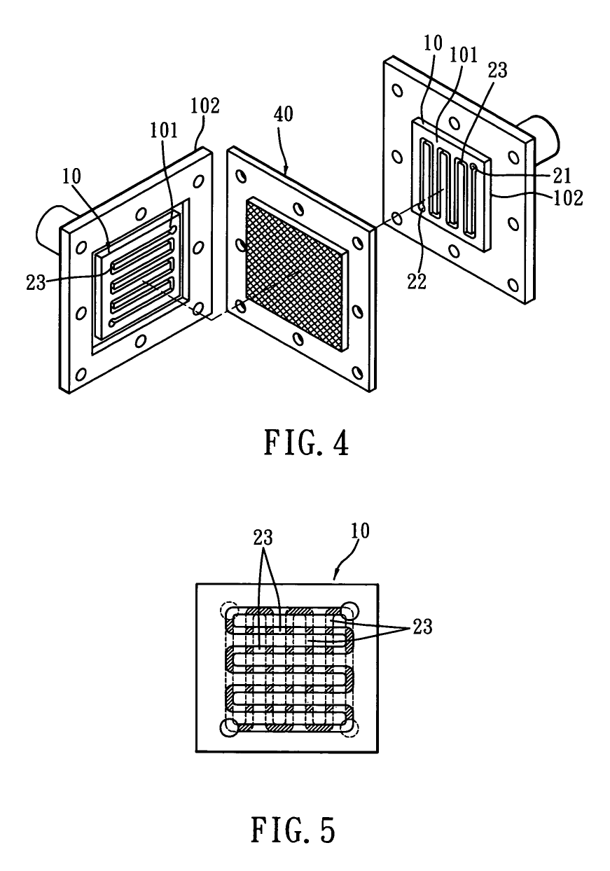

Referring to FIGS. 4 and 5, in the present invention, there is a catalytic unit 40 that is disposed between the first surfaces 101 of these bipolar plates 10. Oxygen and hydrogen gases are supplied into the corresponding plastic plate fluid inlet 21 of the bipolar plates 10. The oxygen and hydrogen gases flowed in the channels 23 will occur an electrochemical reaction at this catalytic unit 40 and then generate water (H₂O), electricity and heat.

As shown in FIGS. 2 and 3, a metal plate fluid inlet 31 and a metal plate fluid outlet 32 are disposed on each metal plate 30. This metal plate fluid inlet 31 is connected with the plastic plate fluid inlet 21. And, this metal fluid outlet 32 is connected with the plastic plate fluid outlet 22. Based on such design, the specific gases (such as hydrogen and oxygen) that can flow in the channels 23 in the bipolar plates 10.

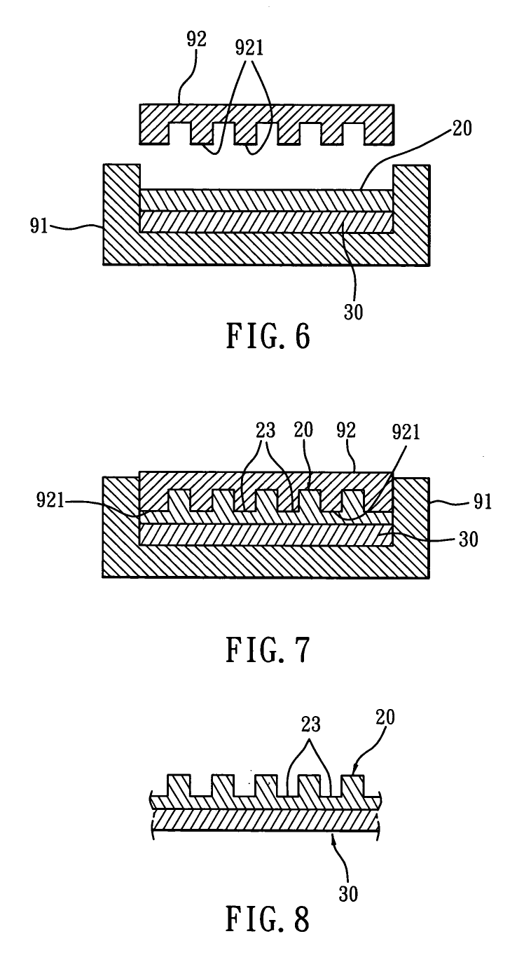

As illustrated in FIGS. 6, 7 and 8, the bipolar plate 10 of the present invention is manufactured by the following steps. First, clean the metal plate 30. Place this metal plate in a first mold 91. Cover the conductive plastic plate 20 on the metal plate 30 (it is better to be heated to a specific warm/hot condition so that it is easier to proceed a forming process by a press). Furthermore, cover a second mold 92 on the first mold 91 as shown in FIG. 7. Then, apply a pre-determined force on the second mold 92. The mold protrusions 921 of the second mold 92 will press on the conductive plastic plate 20. Hence, a channel 23 is formed on the conductive plate 20.

Of course, except the above-mention heat-pressing method, the existing injection-molding method can be used. About the bipolar plates of this invention, these methods are suitable for mass production.

The advantages and disadvantages can be summarized as follows:

[1] It can significantly reduce the manufacturing cost. This invention can be made by a low-cost conductive material (the conductive plastic plate) and metal plates via the heat-pressing or injection-mold. It is suitable for mass production and reducing the manufacturing cost.

[2] Its anti-corrosion capability is excellent. In this invention, the bipolar plate is consisted by the conductive plastic plate and the metal plate. More specifically, the electrochemical reaction occurs on the catalytic unit that is positioned between these conductive plastic plates. The metal plate will not be corroded. So, the life of the bipolar plates can be prolonged.

[3] It can produce fuel cells having complicated bipolar structures. The bipolar plates can be manufactured by heat-pressing or injection molding, even though they have very complicated structure formed on the conductive plastic plates. Thus, this invention is suitable for mass production with low manufacturing cost by heat-pressing or injection molding.

The above embodiments are only used to illustrate the present invention, not intended to limit the scope thereof. Many modifications of the above embodiments can be made without departing from the spirit of the present invention.

What is claimed is:

1. A fuel cell having composite bipolar plates comprising a pair of bipolar plates, each bipolar plate having a first surface and a second surface, each bipolar plate including:
a conductive plastic plate having a first plastic surface and a second plastic surface, said first plastic surface being disposed on said first surface, said conduction plastic portion comprising:
(a) a plastic plate fluid inlet;
(b) a plastic plate fluid outlet; and
(c) a substantially recessed channel formed on said first plastic surface of said conductive plastic plate; and
a metal plate having a first metal surface and a second metal surface, said first metal surface being disposed on said second surface of said bipolar plate, said second metal surface being connected with said second plastic surface.

2. The fuel cell having composite bipolar plates as claimed in claim 1, wherein
a metal plate fluid inlet and a metal plate fluid outlet are disposed on each metal plate; said metal plate fluid inlet is connected with said plastic plate fluid inlet; and, said metal fluid outlet is connected with the plastic plate fluid outlet.

3. The fuel cell having composite bipolar plates as claimed in claim 1, wherein
said conductive plastic plate and said metal plate being combined together by heat-pressing and injection molding.

4. The fuel cell having composite bipolar plates as claimed in claim 1, wherein
said channel being recessed and formed on said conductive plastic plate by heat-pressing or injection molding.

5. The fuel cell having composite bipolar plates as claimed in claim 1, further comprising a first mold and a second mold so as to for said channels being by heat-pressing or injection molding.
